(19) United States
(12) Patent Application Publication
(10) Pub. No.: US 2026/0339353 A1
(43) Pub. Date: Oct. 29, 2026

(54) INVENTORY MANAGEMENT APPARATUS

(71) Applicant: paymentinapp Inc., Seoul (KR)

(72) Inventor: Jung Hyung SUH, Seoul (KR)

(21) Appl. No.: 19/206,083

(22) Filed: May 13, 2025

(30) Foreign Application Priority Data
Apr. 29, 2025 (KR) 10-2025-0056171

(51) Int. Cl. G05D 1/69; G05D 1/644; G05D 105/00; G05D 109/10; G05D 109/20; G05D 111/10; G05D 111/30; G05D 111/50; G06Q 10/087; H04W 4/44

(52) U.S. Cl. CPC G05D 1/69; G05D 1/644; G06Q 10/087; H04W 4/44; G05D 2105/57; G05D 2109/14; G05D 2109/20; G05D 2111/17; G05D 2111/32; G05D 2111/34; G05D 2111/52

(57) ABSTRACT

An inventory management apparatus is disclosed. The apparatus is configured to manage product inventory placed on a plurality of shelves arranged in vertical and horizontal directions along an aisle of a defined space. The apparatus comprises: a first moving apparatus configured to move in a horizontal direction along an aisle or the ceiling of the defined space, and to calculate a position of the first moving apparatus within the defined space using one or more inertial measurement sensors; and a second moving apparatus configured to, after the first moving apparatus is positioned adjacent to a first shelf on which a first product subject to inventory management is placed, move in a direction perpendicular to the ground to capture an image of the first product, and to calculate a relative position with respect to the first moving apparatus.

### CROSS-REFERENCE TO RELATED APPLICATION

This application claims the benefit of priority under 35 U.S.C. § 119(a) to Korean Patent Application No. 10-2025-0056171, filed on Apr. 29, 2025, with the Korean Intellectual Property Office the entire contents of which is incorporated herein by reference.

### BACKGROUND

### Technical Field

The present disclosure relates to an inventory management apparatus, and more particularly, to an apparatus capable of efficiently managing inventory in large-scale logistics centers, manufacturing plants, and large retail stores.

### Background Art

With the widespread use of the Internet, the e-commerce market has experienced rapid growth. In such a market, product orders and payments are conducted via online networks, and the ordered products are delivered to customer-designated destinations through delivery services.

When a product order is received through e-commerce, the seller places a purchase order, and the corresponding product is delivered to a logistics center. At the logistics center, the product is unloaded, and its quality and quantity are inspected. Thereafter, the product undergoes a shelving process and is subsequently made available for ordering.

Since a single logistics center stores and manages a vast number of different types of products, it is extremely important to efficiently identify the sales status and inventory level of each product. Accordingly, technologies employing drones to monitor and manage product inventory within large-scale logistics centers have recently been proposed.

For example, a plurality of shelves (e.g., pallet racks) in a large-scale logistics center may store different types of products. A drone equipped with a camera may fly through the logistics center and capture images of specific shelves, and the captured images may be transmitted to a server or the like. The server may perform an artificial intelligence (AI)-based inference process using the transmitted images to identify the types and quantities of products stored on the corresponding shelves.

Such a drone-based inventory management method has the advantage of improving efficiency by eliminating the need for workers to move directly within the logistics center. However, conventional drones generally have a short flight time of approximately 20 minutes, and it is difficult to equip them with high-performance computing devices, which results in low accuracy in position measurement.

In addition, when the entire video captured by the camera mounted on the drone is transmitted to the server, an increase in recording time results in a larger video file size, thereby decreasing transmission efficiency.

### SUMMARY OF THE DISCLOSURE

The present disclosure is directed to providing an inventory management apparatus capable of further improving inventory management efficiency within a large-scale logistics center.

According to the present disclosure, inventory management efficiency can be improved by employing a combination of a first moving apparatus configured to move in a horizontal direction and a second moving apparatus configured to move in a vertical direction.

In addition, the present disclosure enables control over the timing of product image capture. Since the captured images are preprocessed and transmitted over a network, transmission efficiency can be improved.

To achieve the above-described objective, an embodiment of the present disclosure provides an inventory management apparatus for managing product inventory placed on a plurality of shelves arranged in vertical and horizontal directions along an aisle of a defined space. The apparatus comprises: a first moving apparatus configured to move in a horizontal direction along an aisle or the ceiling of the defined space, and to calculate a position of the first moving apparatus within the space using one or more inertial measurement sensors; and a second moving apparatus configured to, after the first moving apparatus has been positioned adjacent to a first shelf on which a first product subject to inventory management is placed, move in a direction perpendicular to the ground to capture an image of the first product placed on the first shelf, and to calculate a relative position with respect to the first moving apparatus.

The first moving apparatus may be an autonomous mobile robot comprising an acceleration sensor, a rotation sensor, a direction sensor, a LiDAR, and a camera.

The second moving apparatus may be a drone that is mounted on an upper portion of the first moving apparatus, moves in the mounted state, and is configured to initiate flight at a position adjacent to the first shelf.

The first moving apparatus comprises a plurality of signal transmitters configured to transmit wireless signals from a plurality of different positions, and the second moving apparatus is configured to calculate a relative position with respect to the first moving apparatus by using a plurality of wireless signals received from the plurality of signal transmitters after flying in a vertical direction.

The second moving apparatus is configured to start capturing an image of the first product placed on the first shelf after a code or tag located on the first shelf is recognized.

The second moving apparatus is configured to perform preprocessing including downsizing of the captured image and to transmit the preprocessed image to the first moving apparatus, and the first moving apparatus is configured to perform inference for inventory management based on the preprocessed image.

The first moving apparatus is configured to transmit the inference result to a server through a network.

The first moving apparatus is configured to calculate an optimal path for the second moving apparatus through a digital twin-based simulation.

The second moving apparatus is configured to perform charging on the autonomous mobile robot in a contact or contactless manner.

The first moving apparatus is configured to move along a rail installed on a ceiling of an aisle of the defined space, and the second moving apparatus is configured to move downward in a vertical direction after being positioned adjacent to the first shelf.

### BRIEF DESCRIPTION OF DRAWINGS

FIG. 1 is a diagram illustrating an inventory management system according to an embodiment of the present disclosure.

FIG. 2 is a diagram illustrating a detailed configuration of a first moving apparatus according to an embodiment of the present disclosure.

FIG. 3 is a diagram illustrating a state in which the first moving apparatus is carrying the second moving apparatus according to an embodiment of the present disclosure.

FIG. 4 is a diagram illustrating the internal structure of a large-scale logistics center according to an embodiment of the present disclosure.

FIG. 5 is a diagram illustrating an inventory management apparatus according to another embodiment of the present disclosure.

### DETAILED DESCRIPTION

The present disclosure is susceptible to various modifications and may take on several embodiments. Specific embodiments are illustrated in the drawings and described in detail in the detailed description. However, this is not intended to limit the present disclosure to the particular forms disclosed, and it is to be understood that all modifications, equivalents, and substitutions that fall within the spirit and scope of the present disclosure are included.

The terminology used in this specification is intended solely for the purpose of describing particular embodiments and is not intended to be limiting of the present disclosure. As used herein, the singular forms also include the plural forms unless the context clearly indicates otherwise. In this specification, the terms “include,” “have,” and any variations thereof are intended to specify the presence of stated features, integers, steps, operations, components, elements, or combinations thereof, but do not preclude the presence or addition of one or more other features, integers, steps, operations, components, elements, or combinations thereof.

In addition, the components of the embodiments described with reference to the drawings are not necessarily limited to those embodiments alone, but may be implemented in other embodiments as long as the technical spirit of the present disclosure is maintained. It is also to be understood that, even if not explicitly described, multiple embodiments may be combined and implemented as a single embodiment.

In the description with reference to the accompanying drawings, identical or corresponding components may be assigned the same or similar reference numerals regardless of the specific figure, and redundant explanations thereof may be omitted. In addition, detailed descriptions of well-known technologies related to the present disclosure may be omitted if it is determined that such descriptions would unnecessarily obscure the gist of the present disclosure.

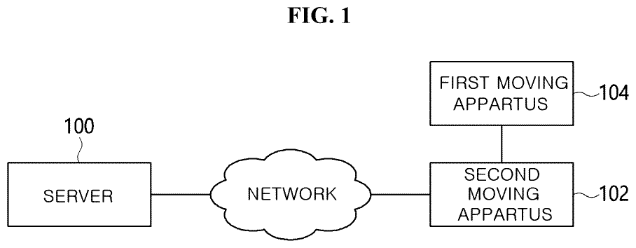

FIG. 1 is a diagram illustrating an inventory management system according to an embodiment of the present disclosure.

As shown in FIG. 1, the inventory management system according to an embodiment of the present disclosure may include a server (100), a first moving apparatus (102) connected to the server (100) via a network, and a second moving apparatus (104) communicably connected to the first moving apparatus (102) via a wired or wireless communication.

The server (100) may receive location information and images associated with products placed on a plurality of shelves from the first moving apparatus (102) which is configured to move within a large-scale logistics center, manufacturing plant, or large retail store, and may infer the remaining quantity of the products based on the received information.

Here, the location information may correspond to a position at which a product to be imaged is placed, the position being determined based on the movements of the first moving apparatus (102) and the second moving apparatus (104).

Hereinafter, the description will focus on the inventory management apparatus according to an embodiment of the present disclosure, which manages the inventory of products placed on a plurality of shelves within a large-scale logistics center.

The first moving apparatus (102) according to an embodiment of the present disclosure is configured to move in a horizontal direction (xy-direction) along an aisle or the ceiling of the logistics center, and to calculate the position of the first moving apparatus within the logistics center using one or more inertial measurement sensors.

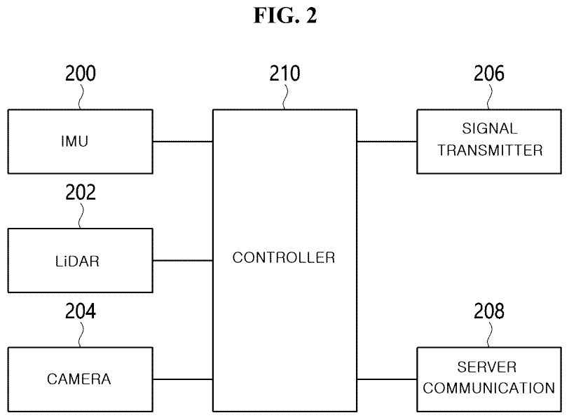

FIG. 2 is a diagram illustrating a detailed configuration of the first moving apparatus according to an embodiment of the present disclosure.

As shown in FIG. 2, the first moving apparatus (102) may include an inertial measurement unit (IMU, 200) configured to measure acceleration, rotation, and direction, a LiDAR (202) configured to measure distance, a camera (204), a signal transmitter (206), a server communication module (208), and a controller (210).

The first moving apparatus (102) may be an autonomous mobile robot configured to travel along an aisle of the logistics center according to a preconfigured travel plan.

In addition, the first moving apparatus (102) may be configured to store map data of the large-scale logistics center in advance, and to determine an optimal path to a predetermined location (e.g., a shelf on which a product subject to inventory management is placed) through a digital twin-based simulation.

The first moving apparatus (102) may be configured to calculate a relative position from an initial position within the indoor large-scale logistics center using the IMU (200), and to move while avoiding obstacles using the LiDAR (202) and the camera (204).

In addition, the first moving apparatus (102) may be configured to directly capture images of products placed on shelves that are within its field of view or accessible range, such as products placed on the floor, using the camera (204).

After the first moving apparatus (102) is positioned adjacent to a first shelf on which a first product subject to inventory management is placed, the second moving apparatus (104) may move in a direction perpendicular to the ground to capture an image of the first product placed on the first shelf.

According to an embodiment of the present invention, the second moving apparatus (104) may be a drone that moves while being mounted on an upper portion of the autonomous mobile robot, and is configured to initiate flight at a position adjacent to the first shelf.

Hereinafter, the description will focus on an embodiment in which the second moving apparatus (104) is implemented as a drone.

As described above, after the first moving apparatus (102) is positioned adjacent to a first shelf on which a first product subject to inventory management is placed, the second moving apparatus (104) may initiate flight and move toward the first shelf.

According to an embodiment of the present disclosure, a plurality of signal transmitters (206) may be provided at different positions. The second moving apparatus (104) may be configured to calculate a relative position with respect to the first moving apparatus (102) by using wireless signals received from the plurality of signal transmitters (206), and to transmit the calculated position to the first moving apparatus (102).

Here, the wireless signals may include, for example, Bluetooth Low Energy (BLE) signals having an effective range of 50 meters, however, the present disclosure is not limited thereto.

The server (100) may transmit identification information and position information of a product subject to inventory management to the first moving apparatus (102).

Based on the received position information, the first moving apparatus (102) moves to the position adjacent to the first shelf. Once the position is reached, the second moving apparatus (104) initiates flight.

The first moving apparatus (102) may be configured to determine, based on relative position information calculated by the second moving apparatus (104), whether the second moving apparatus (104) has accurately approached a target position received from the server (100), and to control the second moving apparatus (104) to start capturing an image at that point.

Additionally, the second moving apparatus (104) may alternatively be configured to start capturing images upon recognizing a code or tag located on the first shelf, and is not limited to the control method described above.

If the second moving apparatus (104) starts capturing images and transmitting them immediately upon the start of flight, the amount of data to be transmitted may increase, and inference efficiency may be degraded.

Accordingly, the system may be configured to control the timing at which image capturing is initiated, such that capturing is performed from an appropriate point in time, thereby improving overall system efficiency.

The second moving apparatus (104) may be configured to perform preprocessing, such as downsizing, on the captured images, and to transmit the preprocessed images to the first moving apparatus (102).

Here, the preprocessed images may include both video and still images, without being limited thereto.

The controller (210) of the first moving apparatus (102) may be configured to perform inference necessary for inventory management based on the received preprocessed images, and to transmit the inference result to the server (100).

For example, the second moving apparatus (104) may be configured to perform preprocessing by converting original 4K resolution video into grayscale images having a resolution of 640×480 pixels and a frame rate of 10 fps or lower. The first moving apparatus (102) may then perform inventory inference at high speed based on a high-performance deep learning inference model.

With this configuration, the amount of data to be transmitted can be reduced by approximately 97% or more, compared to a conventional method in which the second moving apparatus (104) transmits original video in real time during flight.

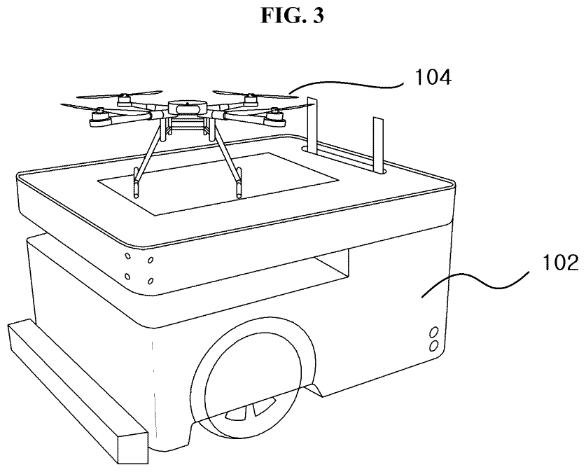

FIG. 3 is a diagram illustrating a state in which the first moving apparatus is carrying the second moving apparatus, according to an embodiment of the present disclosure.

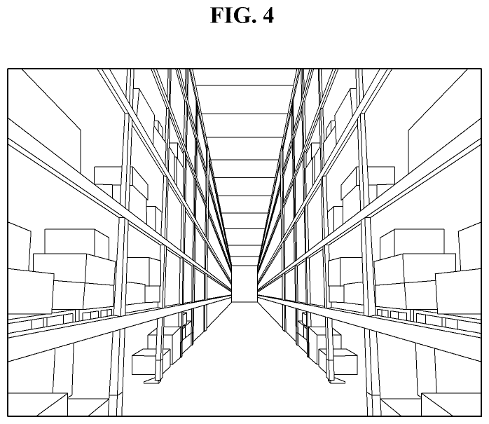

As shown in FIG. 3, the second moving apparatus (104), which is a drone, is mounted on the first moving apparatus (102) and may move, while being mounted, to a predetermined position along an aisle of a large-scale logistics center in which a plurality of shelves are arranged on both sides, as illustrated in FIG. 4.

The first moving apparatus (102), according to an embodiment of the present disclosure, may include a charging module for the second moving apparatus (104), and may be configured to charge the second moving apparatus (104) by at least one of a wired method or a wireless method.

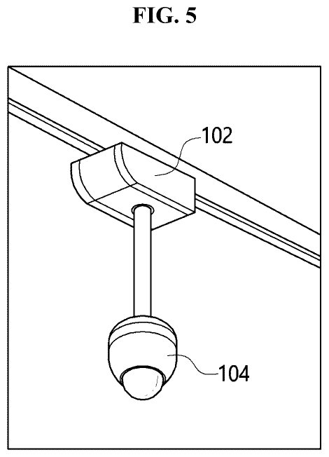

FIG. 5 is a diagram illustrating an inventory management apparatus according to another embodiment of the present disclosure.

In the foregoing embodiment, inventory management was described using a configuration that employs an autonomous mobile robot and a drone. However, as shown in FIG. 5, the first moving apparatus (102), according to the present embodiment, may be configured to move in a horizontal direction along a rail installed on the ceiling of the logistics center.

In addition, the second moving apparatus (104), while being mounted on the first moving apparatus (102), may be configured to have an adjustable length, and may be further configured to move in a vertical direction from the first moving apparatus (102) to perform image capturing.

Here, the second moving apparatus (104) may include a rotatable camera module, and may be configured to capture images of products in a desired direction by rotating to a predetermined angle.

With this configuration, after the first moving apparatus (102) reaches a position adjacent to a first shelf subject to inventory management, the second moving apparatus (104) may be configured to extend downward, i.e., in a vertical direction, and to perform inventory management by capturing an image of a first product placed on the first shelf.

The above-described embodiments of the present disclosure are provided for illustrative purposes only, and various modifications, alterations, and additions may be made by those skilled in the art without departing from the spirit and scope of the present disclosure. Such modifications, alterations, and additions shall be construed as falling within the scope of the following claims.

What is claimed is:

1. An apparatus for managing product inventory placed on a plurality of shelves arranged in vertical and horizontal directions along an aisle of a defined space, the apparatus comprising:
a first moving apparatus configured to move in the horizontal direction along the aisle or a ceiling of the defined space, and to calculate a position of the first moving apparatus within the defined space using one or more inertial measurement sensors; and
a second moving apparatus configured to, after the first moving apparatus has been positioned adjacent to a first shelf on which a first product subject to inventory management is placed, move in a direction perpendicular to ground to capture an image of the first product placed on the first shelf, and to calculate a relative position with respect to the first moving apparatus.

2. The apparatus of claim 1, wherein the first moving apparatus is an autonomous mobile robot comprising an acceleration sensor, a rotation sensor, a direction sensor, a LiDAR, and a camera.

3. The apparatus of claim 2, wherein the second moving apparatus is a drone that is mounted on an upper portion of the first moving apparatus, moves in the mounted state, and is configured to initiate flight at a position adjacent to the first shelf.

4. The apparatus of claim 3, wherein the first moving apparatus comprises a plurality of signal transmitters configured to transmit wireless signals from a plurality of different positions,
and wherein the second moving apparatus is configured to calculate a relative position with respect to the first moving apparatus by using a plurality of wireless signals received from the plurality of signal transmitters after flying in the vertical direction.

5. The apparatus of claim 4, wherein the second moving apparatus is configured to start capturing an image of the first product placed on the first shelf after a code or tag located on the first shelf is recognized.

6. The apparatus of claim 5, wherein the second moving apparatus is configured to perform preprocessing including downsizing of the captured image and to transmit the preprocessed image to the first moving apparatus,
and wherein the first moving apparatus is configured to perform inference for inventory management based on the preprocessed image.

7. The apparatus of claim 6, wherein the first moving apparatus is configured to transmit inference result to a server through a network.

8. The apparatus of claim 3, wherein the first moving apparatus is configured to calculate an optimal path for the second moving apparatus through a digital twin-based simulation.

9. The apparatus of claim 2, wherein the second moving apparatus is configured to perform charging on the autonomous mobile robot in a contact or contactless manner.

10. The apparatus of claim 1, wherein the first moving apparatus is configured to move along a rail installed on the ceiling of the defined space,
and wherein the second moving apparatus is configured to move downward in the vertical direction after being positioned adjacent to the first shelf.
